(19) United States
(12) Patent Application Publication
(10) Pub. No.: US 2024/0367257 A1
(43) Pub. Date: Nov. 7, 2024

(54) METHODS FOR LARGE-SCALE OPTICAL MANUFACTURING

(71) Applicant: NIKON CORPORATION, Tokyo (JP)

(72) Inventors: Daniel Gene SMITH, Tucson, AZ (US); Michael Birk BINNARD, Belmont, CA (US); Alton Hugh PHILLIPS, Oro Valley, AZ (US); Heather Lynn DURKO, Tucson, AZ (US); GO ICHINOSE, Fukaya-shi (JP); Kaneyuki NAITO, Kumagaya-shi (JP)

(73) Assignee: NIKON CORPORATION, Tokyo (JP)

(21) Appl. No.: 18/573,635

(22) PCT Filed: Jun. 24, 2022
(86) PCT No.: PCT/US2022/034854

§ 371 Date: Dec. 22, 2023

Related U.S. Application Data
(60) Provisional application No. 63/216,371, filed on Jun. 29, 2021.

(51) Int. Cl. B23K 26/03; B23K 26/60; B23K 101/34

(52) U.S. Cl. CPC B23K 26/032; B23K 26/60; B23K 2101/34

(57) ABSTRACT

Systems and methods are disclosed that address the problem of large-scale optical manufacturing of microstructures. The systems and methods utilize one or more optical processing systems to generate a first set of alignment marks in a first region on a surface. The optical processing systems then move their focus to a second region on the surface. The second region generally partially overlaps the first region such that the optical processing systems can detect the location of the first set of alignment marks. The optical processing systems then generate a second set of alignment marks based on the location of the first set of alignment marks. This process is repeated in an iterative manner until alignment marks have been generated on all regions of the surface. The alignment marks can be used to optically align one or more optical processing systems configured to produce 3D structures on the surface.

### CROSS-REFERENCE

The present application claims priority to U.S. Provisional Patent Application No. 63/216,371, entitled “SYSTEMS AND METHODS FOR LARGE-SCALE OPTICAL MANUFACTURING,” filed on Jun. 29, 2021, which application is incorporated herein by reference in its entirety for all purposes.

### BACKGROUND OF THE INVENTION

Optical systems, such as laser systems, may be utilized to perform manufacturing operations. Laser systems may be used to ablate material from the surface of an object in order to produce three-dimensional (3D) patterns in the object. Such systems find use in manufacturing a variety of patterns for a variety of applications. For example, such systems may be used to pattern surfaces with aerodynamic riblets. Such riblets may reduce aerodynamic drag on surfaces such as the wings, fuselage, or propeller of an aircraft, or the blades of a wind or gas turbine. But it may be difficult to apply these optical systems to the production of 3D patterns in surfaces that are much larger than a field-of-view (FOV) of the optical system. The FOV may be expanded using a variety of optical components such as lenses and telescopes, but this may make it difficult to produce micro-structured patterns. Accordingly, presented herein are systems and methods for large-scale optical manufacturing.

### BRIEF DESCRIPTION OF THE DRAWINGS

Various embodiments of the invention are disclosed in the following detailed description and the accompanying drawings.

FIG. 1 shows a flowchart depicting an exemplary method for large-scale optical manufacturing.

FIGS. 2A-2F show an example of the method of FIG. 1 carried out to optically process eight regions.

FIG. 2A shows a first set of alignment marks on a first region of a surface.

FIG. 2B shows a second set of alignment marks on a second region of the surface.

FIG. 2C shows a third set of alignment marks on a third region of the surface.

FIG. 2D shows fourth, fifth, sixth, seventh, and eighth sets of alignment marks on fourth, fifth, sixth, seventh, and eighth regions of the surface.

FIG. 2E shows optical processing to generate structures on the first region.

FIG. 2F shows optical processing to generate structures on each of the second, third, fourth, fifth, sixth, seventh, and eighth regions.

FIG. 3A shows an example of an alignment mark having a diamond shape.

FIG. 3B shows an example of an alignment mark having a cross shape.

FIG. 3C shows an example of an alignment mark having a manji shape.

FIG. 3D shows an example of an alignment mark having a Z shape.

FIG. 4 shows a schematic depicting an exemplary system for large-scale optical manufacturing.

FIG. 5 shows a block diagram of a computer system for large-scale optical manufacturing.

### DETAILED DESCRIPTION

The invention can be implemented in numerous ways, including as a process: an apparatus: a system: a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “or” shall convey both disjunctive and conjunctive meanings. For instance, the phrase “A or B” shall be interpreted to include element A alone, element B alone, and the combination of elements A and B.

Recent advances in optical manufacturing systems allow the use of short, high-power optical pulses to ablate material from the surface of an object in order to produce three-dimensional (3D) patterns in the object. Such systems find use in manufacturing a variety of patterns for a variety of applications. For example, such systems may be used to pattern surfaces with aerodynamic riblets. Such riblets may reduce aerodynamic drag on surfaces such as the wings, fuselage, or propeller of an aircraft, or the blades of a wind or gas turbine. However, it may be difficult to apply these systems to the production of 3D patterns in surfaces that are much larger than a field-of-view (FOV) of the optical system. The FOV may be expanded using a variety of optical components such as lenses and telescopes, but this may make it difficult to produce micro-structured patterns such as riblets.

Accordingly, the problem of large-scale optical manufacturing of microstructures is addressed by the systems and methods for large-scale optical manufacturing disclosed herein. The systems and methods utilize one or more optical processing systems to generate a first set of alignment marks and, in some embodiments, desired 3D structures (such as riblets), in a first region on a surface. During processing of the first region, the position and orientation of the optical processing systems relative to the target surface is measured and controlled based on the first set of alignment marks. The optical processing systems then move their focus to a second region on the surface. The second region generally partially overlaps the first region such that the optical processing systems can detect the location of the first set of alignment marks. The optical processing systems then generate a second set of alignment marks and, in some embodiments, the desired 3D structures, in a second region of the surface based on the location of the first set of alignment marks. After generation of the second set of alignment marks, control of the position and orientation of the optical processing systems is based on the second set of alignment marks, and the desired 3D structures can be generated to overwrite the first set of alignment marks. This process is repeated in an iterative manner until 3D structures have been generated on all regions of the surface. In alternative embodiments, all of the sets of alignment marks may be formed on the target surface and subsequently the alignment marks may then be used to optically align one or more optical processing systems configured to produce the desired 3D structures on the surface.

A method for processing a surface is disclosed herein. The method generally comprises: (a) optically generating at least one first alignment mark on a first region of a surface using a first optical processing system; and (b) optically generating at least one second alignment mark on a second region of the surface based on a position of the at least one first alignment mark using the second optical processing system. In some embodiments, the at least one first alignment mark comprises a first set of alignment marks and the at least on second alignment mark comprise a second set of alignment marks. In some embodiments, the second region is different from the first region. In some embodiments, the first optical processing system or the second optical processing system comprise a laser processing system. In some embodiments, the first optical processing system and the second optical processing system are different. In some embodiments, the first optical processing system and the second optical processing system are the same. In some embodiments, the surface is selected from the group consisting of: a wing of an aircraft, a fuselage of an aircraft, a propeller of an aircraft, a tail of an aircraft, a blade of a wind turbine, and a blade of a gas turbine. In some embodiments, a first size of the first region corresponds to a first field of view (FOV) of the first optical processing system. In some embodiments, a first size of the first region is smaller than a first FOV of the first optical processing system. In some embodiments, a second size of the second region corresponds to a second FOV of the second optical processing system. In some embodiments, a second size of the second region is smaller than a second FOV of the first optical processing system. In some embodiments, the first and second regions partially overlap. In some embodiments, (a) or (b) comprises marking the at least one first alignment mark on the first region or the at least one second alignment mark on the second region. In some embodiments, the first region or the second regions comprises a base coat and a top coat, and (a) or (b) comprises burning the at least one first alignment mark or the at least one second alignment mark in the base coat. In some embodiments, (a) or (b) comprises ablating the at least one first alignment mark on the first region or the at least one second alignment mark on the second region. In some embodiments. (a) or (b) comprises ablating the at least one first alignment mark on the first region or the at least one second alignment mark on the second region to an ablation depth that is less than a depth of structures to be generated on the first region or the second region. In some embodiments, the first region or the second region comprises a base coat and a top coat, and (a) or (b) comprises ablating the at least one first alignment mark or the at least one second alignment mark on the base coat. In some embodiments, the at least one first alignment mark comprises one or more guide stars projected on the surface. In some embodiments, the at least one first alignment mark or the at least one second alignment mark is selected from the group consisting of: diamond-shaped alignment marks, cross-shaped alignment marks, manji-shaped alignment marks, and Z-shaped alignment marks. In some embodiments, the method further comprises using a third optical processing system to ablate one or more structures on the first region or the second region. In some embodiments, the one or more structures comprise one or more riblets. In some embodiments, the third optical processing system is the same as the first optical processing system or the second optical processing system. In some embodiments, the third optical processing system is different from the first optical processing system or the second processing optical system.

Further disclosed herein is a method for processing a surface comprising: (a) optically generating at least one first alignment mark on a first region of the surface using a first optical processing system; and (b) processing the surface based on a position of the at least one first alignment mark using a second optical processing system. In some embodiments, the method further comprises optically generating the at least one first alignment mark using a first optical processing system. In some embodiments, the processing of the coat layer is performed using a second optical processing system.

Further disclosed herein is a method for processing a coat layer comprising: (a) detecting at least one first alignment mark formed below a coat layer through the coat layer; and (b) processing the coat layer based on a position of the at least one first alignment mark below the coat layer.

Further disclosed herein is a system for large-scale optical manufacturing. The system generally comprises: a first optical processing system configured to: (i) optically generate at least one first alignment mark on a first region of a surface; and a second optical processing system configured to: (ii) optically generate at least one second alignment mark on a second region of the surface based on a position of the at least one first alignment mark. In some embodiments, the at least one first alignment mark comprises a first set of alignments marks and the at least one second alignment mark comprises a second set of alignment marks. In some embodiments, the second region is different from the first region. In some embodiments, the first optical processing system or the second optical processing system comprise a laser processing system. In some embodiments, the first optical processing system and the second optical processing system are different. In some embodiments, the first optical processing system and the second optical processing system are the same. In some embodiments, the surface is selected from the group consisting of: a wing of an aircraft, a fuselage of an aircraft, a propeller of an aircraft, a tail of an aircraft, a blade of a wind turbine, and a blade of a gas turbine. In some embodiments, a first size of the first region corresponds to a first field of view (FOV) of the first optical processing system. In some embodiments, a first size of the first region is smaller than a first FOV of the first optical processing system. In some embodiments, a second size of the second region corresponds to a second FOV of the second optical processing system. In some embodiments, a second size of the second region is smaller than a second FOV of the second optical processing system. In some embodiments, the first and second regions partially overlap. In some embodiments, (i) or (ii) comprises marking the at least one first alignment mark on the first region or the at least one second alignment mark on the second region. In some embodiments, the first region or the second region comprises a base coat and a top coat, and (i) or (ii) comprises burning the at least one first alignment mark or the at least one second alignment mark in the base coat. In some embodiments, (i) or (ii) comprises ablating the at least one first alignment mark on the first region or the at least one second alignment mark on the second region. In some embodiments. (i) or (ii) comprises ablating the at least one first alignment mark on the first region or the at least one second alignment mark on the second region to an ablation depth that is less than a depth of structures to be generated on the first region or the second region. In some embodiments, the first region or the second region comprises a base coat and a top coat, and (i) or (ii) comprises ablating the at least one first alignment mark or the at least one second alignment mark on the base coat. In some embodiments, the at least one first alignment mark comprises one or more guide stars projected on the surface. In some embodiments, the at least one first alignment mark or the at least one second alignment mark is selected from the group consisting of: diamond-shaped alignment marks, cross-shaped alignment marks, manji-shaped alignment marks, and Z-shaped alignment marks. In some embodiments, the system further comprises a third optical processing system configured to ablate one or more structures on the first region or the second region. In some embodiments, the one or more structures comprise one or more riblets. In some embodiments, the third optical processing system is the same as the first optical processing system or the second optical processing system. In some embodiments, the third optical processing system is different from the first optical processing system or the second optical processing system.

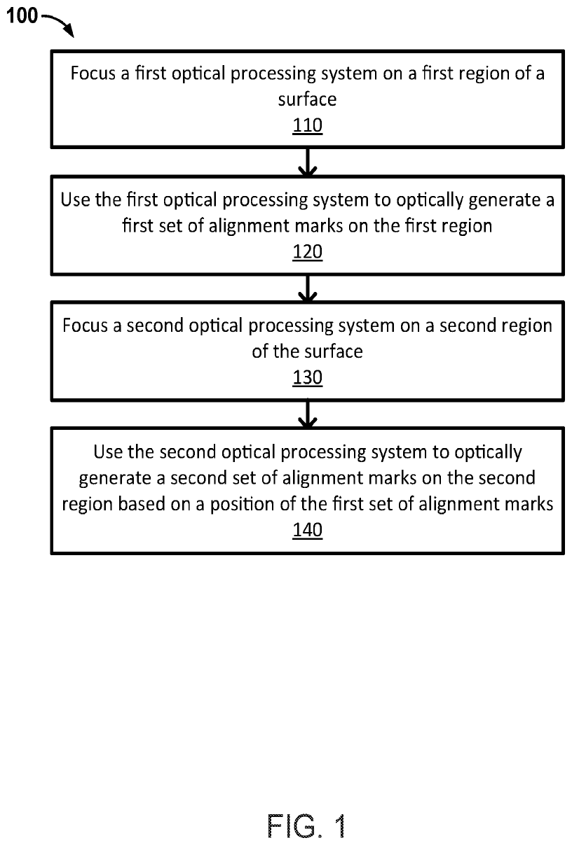

FIG. 1 shows a flowchart depicting an exemplary method 100 for large-scale optical manufacturing. In the example shown, a first optical processing system is focused on a first region of a surface at 110. In some embodiments, the surface comprises a wing of an aircraft. In some embodiments, the surface comprises a fuselage of an aircraft. In some embodiments, the surface comprises a propeller of an aircraft. In some embodiments, the surface comprises a tail of an aircraft. In some embodiments, the surface comprises a blade of a wind turbine. In some embodiments, the surface comprises a blade of a gas turbine.

In some embodiments, a first size of the first region corresponds to a first field of view (FOV) of the first optical processing system. In some embodiments, the first size of the first region is at least about 1 square millimeter (mm²), 2 mm², 3 mm², 4 mm². 5 mm². 6 mm², 7 mm², 8 mm², 9 mm², 10 mm², 20 mm², 30 mm², 40 mm², 50 mm². 60 mm², 70 mm², 80 mm², 90 mm², 1 square centimeter (cm²), 2 cm², 3 cm², 4 cm², 5 cm², 6 cm², 7 cm², 8 cm², 9 cm², 10 cm², 20 cm², 30 cm², 40 cm², 50 cm², 60 cm², 70 cm², 80 cm². 90 cm², 1 square decimeter (dm²), 2 dm², 3 dm², 4 dm², 5 dm², 6 dm², 7 dm², 8 dm², 9 dm², 10 dm², 20 dm², 30 dm², 40 dm², 50 dm², 60 dm², 70 dm², 80 dm², 90 dm². 1 square meter (m²), 2 m², 3 m², 4 m². 5 m², 6 m², 7 m², 8 m², 9 m², 10 m², 20 m², 30 m², 40 m², 50 m². 60 m², 70 m², 80 m². 90 m², 100 m², or more. In some embodiments, the first size of the first region is at most about 100 m², 90 m². 80 m², 70 m², 60 m², 50 m², 40 m², 30 m², 20 m², 10 m², 9 m², 8 m², 7 m², 6 m², 5 m², 4 m², 3 m², 2 m², 1 m², 90 dm², 80 dm², 70 dm², 60 dm², 50 dm², 40 dm², 30 dm², 20 dm². 10 dm², 9 dm². 8 dm², 7 dm², 6 dm², 5 dm², 4 dm², 3 dm², 2 dm², 1 dm², 90 cm², 80 cm², 70 cm², 60 cm², 50 cm². 40 cm², 30 cm², 20 cm², 10 cm², 9 cm², 8 cm², 7 cm². 6 cm², 5 cm², 4 cm², 3 cm², 2 cm², 1 cm², 90 mm², 80 mm², 70 mm², 60 mm², 50 mm², 40 mm², 30 mm², 20 mm², 10 mm², 9 mm², 8 mm², 7 mm², 6 mm², 5 mm², 4 mm², 3 mm², 2 mm², 1 mm², or less. In some embodiments, the first size of the first region is within a range defined by any two of the preceding values.

In some embodiments, the first optical processing system comprises a laser processing system. In some embodiments, the first optical processing system comprises a pulsed laser processing system. In some embodiments, the first optical processing system is configured to generate laser pulses.

In some embodiments, the laser pulses have a peak optical power of at least about 1 watt (W), 2 W, 3 W, 4 W, 5 W. 6 W, 7 W, 8 W, 9 W, 10 W, 20 W, 30 W, 40 W, 50 W, 60 W, 70 W, 80 W, 90 W. 100 W, 200 W, 300 W, 400 W, 500 W, 600 W, 700 W, 800 W, 900 W, 1 kilowatt (KW), 2 KW, 3 KW, 4 KW, 5 KW, 6 KW, 7 KW, 8 KW, 9 KW, 10 KW, 20 KW, 30 KW, 40 KW. 50 KW, 60 KW, 70 KW, 80 KW, 90 KW, 100 KW, 200 KW, 300 KW. 400 KW, 500 KW, 600 KW, 700 KW, 800 KW, 900 KW, 1 megawatt (MW), 2 MW, 3 MW, 4 MW, 5 MW, 6 MW, 7 MW, 8 MW, 9 MW, 10 MW, 20 MW, 30 MW, 40 MW, 50 MW, 60 MW, 70 MW, 80 MW, 90 MW, 100 MW, 200 MW, 300 MW, 400 MW, 500 MW, 600 MW, 700 MW, 800 MW, 900 MW, 1 gigawatt (GW), 2 GW, 3 GW, 4 GW, 5 GW, 6 GW. 7 GW, 8 GW. 9 GW, 10 GW, 20 GW, 30 GW. 40 GW, 50 GW, 60 GW, 70 GW, 80 GW, 90 GW, 100 GW. 200 GW, 300 GW, 400 GW, 500 GW, 600 GW, 700 GW, 800 GW, 900 GW, 1,000 GW, or more. In some embodiments, the laser pulses have a peak optical power of at most about 1,000 GW, 900 GW, 800 GW, 700 GW, 600 GW, 500 GW, 400 GW, 300 GW, 200 GW. 100 GW, 90 GW, 80 GW, 70 GW, 60 GW, 50 GW, 40 GW, 30 GW. 20 GW, 10 GW, 9 GW. 8 GW, 7 GW, 6 GW, 5 GW, 4 GW, 3 GW, 2 GW, 1 GW, 900 MW, 800 MW, 700 MW. 600 MW, 500 MW, 400 MW, 300 MW, 200 MW, 100 MW, 90 MW, 80 MW, 70 MW, 60 MW, 50 MW, 40 MW, 30 MW, 20 MW, 10 MW, 9 MW, 8 MW, 7 MW, 6 MW, 5 MW, 4 MW, 3 MW, 2 MW, 1 MW, 900 KW, 800 KW, 700 KW, 600 kW, 500 KW, 400 KW, 300 KW, 200 KW. 100 KW, 90 KW. 80 KW. 70 KW, 60 KW, 50 KW, 40 KW, 30 KW, 20 KW, 10 KW, 9 KW, 8 KW, 7 KW, 6 KW, 5 KW, 4 KW, 3 KW, 2 KW, 1 KW, 900 W, 800 W, 700 W. 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, or less. In some embodiments, the laser pulses have a peak optical power that is within a range defined by any two of the preceding values.

In some embodiments, the laser pulses have a pulse length of at least about 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns, 4 ns, 5 ns, 6 ns. 7 ns, 8 ns, 9 ns, 10 ns, 20 ns. 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (μs), 2 μs, 3 μs, 4 μs, 5 μs, 6 μs, 7 μs, 8 μs, 9 μs, 10 μs, 20 μs, 30 μs, 40 μs, 50 μs. 60 μs, 70 μs, 80 μs, 90 μs, 100 μs, 200 μs, 300 μs, 400 μs, 500 μs, 600 μs, 700 μs, 800 μs, 900 μs, 1,000 μs, or more. In some embodiments, the laser pulses have a pulse length of at most about 1,000 μs, 900 μs, 800 μs, 700 μs, 600 μs. 500 μs, 400 μs, 300 μs, 200 μs, 100 μs, 90 μs, 80 μs, 70 μs, 60 μs, 50 μs, 40 μs, 30 μs, 20 μs, 10 μs, 9 μs, 8 μs. 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, 9 ns, 8 ns, 7 ns, 6 ns, 5 ns, 4 ns, 3 ns, 2 ns, 1 ns, 900 ps, 800 ps, 700 ps. 600 ps, 500 ps, 400 ps, 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps. 3 ps, 2 ps, 1 ps, or less. In some embodiments, the laser pulses have a pulse length that is within a range defined by any two of the preceding values.

In some embodiments, the laser pulses have a pulse energy of at least about 1 picojoule (pJ), 2 pJ, 3 pJ, 4 pJ, 5 pJ, 6 pJ, 7 pJ, 8 pJ, 9 pJ, 10 pJ, 20 pJ, 30 pJ, 40 pJ, 50 pJ, 60 pJ. 70 pJ. 80 pJ, 90 pJ, 100 pJ, 200 pJ, 300 pJ, 400 pJ, 500 pJ, 600 pJ, 700 pJ, 800 pJ, 900 pJ, 1 nanojoule (nJ), 2 nJ, 3 nJ, 4 nJ, 5 nJ, 6 nJ, 7 nJ, 8 nJ, 9 nJ, 10 nJ, 20 nJ, 30 nJ, 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nJ, 900 nJ, 1 microjoule (μJ), 2 μJ, 3 μJ, 4 μJ, 5 μJ, 6 μJ, 7 μJ, 8 μJ, 9 μJ, 10 μJ, 20 μJ, 30 μJ, 40 μJ, 50 μJ, 60 μJ, 70 μJ, 80 μJ, 90 μJ, 100 μJ, 200 μJ, 300 μJ, 400 μJ, 500 μJ, 600 μJ, 700 μJ, 800 μJ, 900 μJ, 1,000 μJ, or more. In some embodiments, the laser pulses have a pulse energy of at most about 1,000 μJ, 900 μJ, 800 μJ, 700 pJ, 600 μJ, 500 μJ, 400 μJ, 300 μJ, 200 J, 100 J, 90 μJ, 80 μJ. 70 μJ, 60 μJ, 50 μJ, 40 μJ, 30 μJ, 20 μJ, 10 μJ, 9 μJ. 8 μJ, 7 μJ, 6 pJ, 5 μJ, 4 J, 3 μJ, 2 μJ, 1 μJ, 900 nJ, 800 nJ, 700 nJ, 600 nJ, 500 nJ, 400 nJ, 300 nJ, 200 nJ, 100 nJ. 90 nJ, 80 nJ, 70 nJ, 60 nJ, 50 nJ, 40 nJ, 30 nJ, 20 nJ, 10 nJ, 9 nJ, 8 nJ, 7 nJ, 6 nJ, 5 nJ, 4 nJ. 3 nJ, 2 nJ. 1 nJ, 900 pJ, 800 pJ, 700 pJ. 600 pJ, 500 pJ, 400 pJ, 300 pJ, 200 pJ, 100 pJ, 90 pJ, 80 pJ, 70 pJ, 60 pJ, 50 pJ, 40 pJ, 30 pJ, 20 pJ, 10 pJ, 9 pJ, 8 pJ, 7 pJ, 6 pJ, 5 pJ. 4 pJ, 3 pJ, 2 pJ, 1 pJ, or less. In some embodiments, the laser pulses have a pulse energy that is within a range defined by any two of the preceding values.

In some embodiments, the laser pulses have a repetition rate of at least about 1 hertz (Hz), 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kilohertz (kHz), 2 kHz, 3 kHz, 4 kHz, 5 KHz, 6 kHz, 7 kHz, 8 kHz. 9 kHz, 10 KHz, 20 kHz, 30 kHz, 40 KHz, 50 kHz, 60 kHz, 70 kHz, 80 kHz, 90 kHz, 100 KHz. 200 KHz. 300 kHz, 400 kHz, 500 kHz, 600 kHz, 700 kHz, 800 kHz, 900 kHz, 1,000 kHz, or more. In some embodiments, the laser pulses have a repetition rate of at most about 1.000 KHz. 900 kHz, 800 kHz, 700 kHz, 600 kHz, 500 kHz, 400 kHz, 300 kHz, 200 kHz, 100 KHz, 90 KHz, 80 KHz, 70 kHz, 60 kHz, 50 kHz, 40 kHz, 30 kHz, 20 KHz, 10 KHz, 9 kHz, 8 kHz, 7 KHz. 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz. 10 Hz. 9 Hz, 8 Hz, 7 Hz, 6 Hz, 5 Hz, 4 Hz, 3 Hz, 2 Hz. 1 Hz, or less. In some embodiments, the laser pulses have a repetition rate that is within a range defined by any two of the preceding values.

In some embodiments, the laser pulses have at least one wavelength of at least about 100 nanometers (nm), 125 nm, 150 nm, 175 nm, 200 nm, 225 nm. 250 nm, 275 nm. 300 nm, 325 nm, 350 nm, 375 nm, 400 nm. 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm. 950 nm, 975 nm, 1 micrometer (μm), 1.1 μm, 1.2 μm, 1.3 μm, 1.4 μm, 1.5 μm, 1.6 μm, 1.7 μm. 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 3.1 μm, 3.2 μm, 3.3 μm, 3.4 μm, 3.5 μm, 3.6 μm, 3.7 μm, 3.8 μm, 3.9 μm, 4 μm. 4.1 μm, 4.2 μm, 4.3 μm, 4.4 μm, 4.5 μm, 4.6 μm, 4.7 μm, 4.8 μm, 4.9 μm, 5μ, 5.1μ, 5.2μ, 5.3 μm, 5.4μ, 5.5 μm, 5.6 μm, 5.7 μm, 5.8 μm, 5.9 μm, 6 μm, 6.1 μm, 6.2 μm, 6.3 μm. 6.4 μm, 6.5 μm, 6.6 μm, 6.7 μm, 6.8 μm, 6.9 μm, 7 μm, 7.1 μm, 7.2 μm, 7.3 μm, 7.4 μm, 7.5 μm, 7.6 μm, 7.7 μm, 7.8 μm, 7.9 μm, 8 μm, 8.1μ, 8.2μ, 8.3 μm, 8.4 μm, 8.5 μm, 8.6μ. 8.7 μm, 8.8 μm, 8.9 μm, 9μ, 9.1μ, 9.2 μm, 9.3 μm, 9.4 μm, 9.5 μm, 9.6 μm, 9.7 μm, 9.8 μm, 9.9 μm, 10 μm, 10.1 μm, 10.2 μm. 10.3 μm, 10.4 μm, 10.5 μm, 10.6 μm. 10.7 μm, 10.8 μm, 10.9 μm, 11 μm, or more. In some embodiments, the laser pulses have at least one wavelength of at most about 11 μm, 10.9 μm, 10.8 μm, 10.7 μm, 10.6 μm. 10.5 μm. 10.4 μm, 10.3 μm, 10.2 μm, 10.1 μm, 10 μm, 9.9 μm, 9.8 μm, 9.7 μm, 9.6 μm, 9.5 μm, 9.4 μm, 9.3 μm. 9.2 μm, 9.1 μm, 9 μm, 8.9 μm, 8.8 μm, 8.7 μm, 8.6 μm, 8.5 μm, 8.4 μm, 8.3 μm, 8.2 μm. 8, 1 μm, 8 μm, 7.9 μm, 7.8 μm, 7.7 μm, 7.6 μm, 7.5 μm, 7.4 μm, 7.3 μm, 7.2 μm, 7.1 μm, 7 μm, 6.9 μm, 6.8 μm, 6.7 μm, 6.6 μm, 6.5 μm, 6.4 μm, 6.3 μm, 6.2 μm, 6.1μ, 6μ, 5.9 μm. 5.8μ, 5.7 μm, 5.6μ, 5.5μ, 5.4μ, 5.3 μm, 5.2 μm, 5.1μ, 5 μm, 4.9 μm, 4.8 μm, 4.7 μm, 4.6 μm, 4.5 μm, 4.4 μm, 4.3 μm, 4.2 μm, 4.1 μm, 4μ, 3.9μ, 3.8 μm, 3.7 μm, 3.6 μm. 3.5μ, 3.4μ, 3.3μ, 3.2μ, 3.1μ, 3 μm, 2.9 μm. 2.8 μm, 2.7 μm, 2.6 μm, 2.5 μm, 2.4 μm, 2.3 μm, 2.2 μm, 2.1 μm, 2 μm, 1.9 μm, 1.8 μm. 1.7 μm, 1.6 μm, 1.5 μm, 1.4 μm, 1.3 μm. 1.2 μm, 1.1 μm, 1 μm, 975 nm, 950 nm. 925 nm, 900 nm, 875 nm, 850 nm, 825 nm, 800 nm, 775 nm, 750 nm, 725 nm. 700 nm, 675 nm, 650 nm, 625 nm, 600 nm, 575 nm, 550 nm. 525 nm, 500 nm, 475 nm, 450 nm, 425 nm, 400 nm, 375 nm, 350 nm, 325 nm, 300 nm, 275 nm, 250 nm, 225 nm, 200 nm. 175 nm, 150 nm, 125 nm. 100 nm, or less. In some embodiments, the laser pulses have at least one wavelength that is within a range defined by any two of the preceding values.

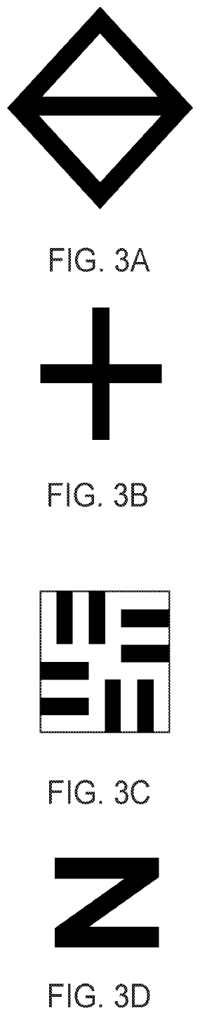

In the example shown, the first optical processing system is used to optically generate a first set of alignment marks on the first region at 120. In some embodiments, the first set of alignment marks have a diamond shape, as described herein with respect to FIG. 3A. In some embodiments, the first set of alignment marks have a cross shape, as described herein with respect to FIG. 3B. In some embodiments, the first set of alignment marks have a manji shape, as described herein with respect to FIG. 3C. In some embodiments, a manji shape comprise a shape comprising perpendicular sets of parallel lines. In some embodiments, the first set of alignment marks have a Z shape, as described herein with respect to FIG. 3D. In some embodiments, the first set of alignment marks have a polygonal shape, such as a triangular, rectangular, pentagonal, hexagonal, heptagonal, octagonal, or other polygonal shape. In FIGS. 3A to 3D, the area of the alignment marks made by the laser from the optical system are shown in black. These areas may be regarded as or referred to as a negative pattern. In some embodiment, the optical system irradiates the laser outside of the black areas in FIGS. 3A to 3D, and the alignment marks are made on the white areas of FIGS. 3A to 3D. These areas may be regarded as or referred to as a positive pattern. In some embodiments, the first set of alignment marks have a curvilinear shape, such as a circular or elliptical shape. In other embodiments, the first set of alignment marks comprises one or more guide stars projected on the surface. In some embodiments, the one or more guide stars are projected on the surface by a projector device (which may correspond to the first optical processing system). In some embodiments, the one or more guide stars projected by the projector device are used to determine a location of an initial region where the first set of alignment marks are to be made. In some embodiments, the location of the initial region may be determined by an image detector. In some embodiments, the optical system makes the one or more alignment marks at the position of the one or more projected guide stars, or at positions determined from the position of the one or more projected guide stars. In some embodiments, riblets are marked on the part based on the one or more alignment marks. In some embodiments, riblets are marked on the first region of the part based on the one or more projected guide stars without making any marks in the first region. In some embodiments, alignment marks are made in the next region based on the position of the one or more guide stars projected on the first region. In some embodiments, a positional relation between a location of the first processing device and a location of the surface is measured. In some embodiments, the positional relation is measured by a sensor that can detect a characteristic part of the surface. In some embodiments, the sensor is a component of the first optical processing system. In some embodiments, a set of alignment marks other than the first set of alignment marks is projected on the surface by the projector device. In some embodiments, a set of alignment marks other than the first set of alignment marks is projected on the surface in addition to the first set of alignment marks. In some embodiments, the one or more guide stars comprise points or pattern of light. In some embodiments, the first optical processing system comprises a reliable reference system (such as a stationary optical system) that defines a known coordinate frame.

In some embodiments, the first set of alignment marks is marked on the first region. In some embodiments, the first set of alignment marks is ablated from the first region. In some embodiments, the first set of alignment marks is patterned on the first region. In some embodiments, the first region comprises a base coat and a top coat. In some embodiments, the first set of alignment marks is marked in the base coat. In some embodiments, the first set of alignment marks is ablated on the base coat. In some embodiments, the first set of alignment marks is ablated to an ablation depth that is less than a depth of structures to be generated on the first region. For example, in some embodiments, the first set of alignment marks is ablated to an ablation depth of at least about 1 μm, 2 μm, 3 μm, 4μ, 5 μm, 6 μm, 7 μm, 8 μm, 9μ, 10 μm, 20 μm, 30 μm, 40 μm, 50 μm, or more. In some embodiments, the first set of alignment marks is ablated to an ablation depth of at most about 50 μm. 40 μm, 30 μm, 20 μm, 10 μm, 9 μm, 8 μm, 7 μm, 6 μm, 5 μm, 4 μm, 3 μm, 2 μm, 1 μm, or less. In some embodiments, the first set of alignment marks is ablated to an ablation depth that is within a range defined by any two of the preceding values. In some embodiments, the structures to be generated on the first region have a depth of at least about 10 μm, 20 μm, 30 μm, 40 μm, 50 μm. 60 μm. 70 μm. 80 μm, 90 μm, 100 μm, 110 μm, 120 μm, 130 μm, 140 μm, 150 μm, 160 μm. 170 μm, 180 μm, 190 μm, 200 μm, or more. In some embodiments, the structures to be generated on the first region have a depth of at most about 200 μm, 190 μm, 180 μm, 170 μm, 160 μm, 150 μm, 140 μm, 130 μm, 120 μm, 110 μm, 100 μm, 90μ, 80μ, 70 μm, 60 μm, 50 μm, 40 μm, 30 μm, 20 μm, 10 μm, or less. In some embodiments, the structures to be generated on the first region have a depth that is within a range defined by any two of the preceding values. For example, in some embodiments, the structures to be generated on the first region have a depth between about 1 μm and about 100 μm, between about 1 μm and about 50 μm, between about 10 μm and about 100 μm, or between about 10 μm and about 50 μm.

In the example shown, a second optical processing system is focused on a second region of the surface at 130. In some embodiments, the second region contains the first set of alignment marks. In some embodiments, a second size of the second region corresponds to a second FOV of the second optical processing system. In some embodiments, the second size of the second region is any size described herein with respect to the first size of the first region. In some embodiments, the second size of the second region is the same as the first size of the first region. In some embodiments, the second size of the second region is different than the first size of the first region. In some embodiments, the first and second regions are different. In some embodiments, the first and second regions overlap. In some embodiments, the first and second regions overlap by at least about 1 mm², 2 mm², 3 mm², 4 mm², 5 mm², 6 mm², 7 mm², 8 mm², 9 mm², 10 mm², 20 mm². 30 mm², 40 mm², 50 mm², 60 mm², 70 mm². 80 mm², 90 mm², 1 cm², 2 cm², 3 cm², 4 cm², 5 cm², 6 cm², 7 cm², 8 cm², 9 cm², 10 cm², 20 cm², 30 cm², 40 cm², 50 cm², 60 cm², 70 cm², 80 cm². 90 cm², 1 dm². 2 dm², 3 dm², 4 dm², 5 dm², 6 dm². 7 dm², 8 dm², 9) dm², 10 dm², 20 dm², 30 dm², 40 dm², 50 dm², 60 dm², 70 dm², 80 dm², 90 dm², 1 m², 2 m², 3 m², 4 m², 5 m², 6 m², 7 m², 8 m². 9 m², 10 m², 20 m², 30 m², 40 m², 50 m², 60 m², 70 m², 80 m², 90 m², 100 m², or more. In some embodiments, the first and second regions overlap by at most about 100 m², 90 m², 80 m², 70 m², 60 m². 50 m², 40 m², 30 m², 20 m², 10 m², 9 m², 8 m², 7 m², 6 m², 5 m², 4 m², 3 m², 2 m², 1 m², 90 dm², 80 dm². 70 dm², 60 dm², 50 dm². 40 dm², 30 dm², 20 dm². 10 dm², 9 dm², 8 dm², 7 dm², 6 dm², 5 dm², 4 dm², 3 dm², 2 dm², 1 dm², 90 cm², 80 cm², 70 cm², 60 cm², 50 cm², 40 cm², 30 cm², 20 cm², 10 cm², 9 cm², 8 cm², 7 cm², 6 cm², 5 cm², 4 cm², 3 cm², 2 cm², 1 cm², 90 mm², 80 mm², 70 mm². 60 mm², 50 mm², 40 mm², 30 mm², 20 mm², 10 mm², 9 mm², 8 mm², 7 mm², 6 mm², 5 mm², 4 mm², 3 mm², 2 mm², 1 mm², or less. In some embodiments, the first and second regions overlap by an amount that is within a range defined by any two of the preceding values.

In some embodiments, the first and second optical processing systems are different. That is, in some embodiments, the first and second optical processing systems are physically distinct from one another. In some embodiments, the first and second optical processing systems utilize one or more similar optical elements. In some embodiment, the first and second optical processing systems utilize one or more dissimilar optical elements. In some embodiments, the first and second optical processing systems are the same. That is, in some embodiments, the first and second optical processing systems constitute a single optical processing system that performs all of operations 110, 120, 130, and 140 described herein with respect to FIG. 1. In some embodiments, the second optical processing system comprises a laser processing system. In some embodiments, the second optical processing system comprises a pulsed laser processing system. In some embodiments, the second optical processing system is configured to generate laser pulses. In some embodiments, the laser pulses have any peak optical power described herein with respect to the first optical processing system. In some embodiments, the laser pulses have any pulse length described herein with respect to the first optical processing system. In some embodiments, the laser pulses have any pulse energy described herein with respect to the first optical processing system. In some embodiments, the laser pulses have any repetition rate described herein with respect to the first optical processing system. In some embodiments, the laser pulses have at least one wavelength described herein with respect to the first optical processing system.

In the example shown, the second optical processing system is used to optically generate a second set of alignment marks on the second region at 140. In some embodiments, the second set of alignment marks are generated based on a position of the first set of alignment marks. In some embodiments, the second set of alignment marks have a diamond shape, as described herein with respect to FIG. 3A. In some embodiments, the second set of alignment marks have a cross shape, as described herein with respect to FIG. 3B. In some embodiments, the second set of alignment marks have a manji shape, as described herein with respect to FIG. 3C. In some embodiments, the second set of alignment marks have a Z shape, as described herein with respect to FIG. 3D. In some embodiments, the second set of alignment marks have a polygonal shape, such as a triangular, rectangular, pentagonal, hexagonal, heptagonal, octagonal, or other polygonal shape. In some embodiments, the second set of alignment marks have a curvilinear shape, such as a circular or elliptical shape.

In some embodiments, the second set of alignment marks is marked on the second region. In some embodiments, second set of alignment marks is ablated from the second region. In some embodiments, the second set of alignment marks is patterned on the second region. In some embodiments, the second region comprises a base coat and a top coat. In some embodiments, the second set of alignment marks is marked in the base coat. In some embodiments, the second set of alignment marks is ablated on the base coat. In some embodiments, the second set of alignment marks is ablated to an ablation depth that is less than a depth of structures to be generated on the first region. For example, in some embodiments, the second set of alignment marks is ablated to any ablation depth described herein with respect to the first set of alignment marks. In some embodiments, the structures to be generated on the first region have any depth described herein.

In some embodiments, after generation of the second set of alignment marks, control of the position and orientation of the optical processing systems is based on the second set of alignment marks, and the desired 3D structures can be generated to over-write the first set of alignment marks.

In some embodiments, the method 100 further comprises repeating operations 130 and 140 to generate a plurality of sets of alignment marks on a plurality of regions on the surface. For example, in some embodiments, the method further comprises performing operations 130 and 140 to generate a third set of alignment marks on a third region based on the first or second set of alignment marks. In some embodiments, the third region partially overlaps the first or second region and contains the first or second set of alignment marks. In some embodiments, the method further comprises performing operations 130 and 140 to generate a fourth set of alignment marks on a fourth region based on the first, second, or third set of alignment marks. In some embodiments, the fourth region partially overlaps the first, second, or third region and contains the first, second, or third set of alignment marks. In some embodiments, the operations 130 and 140 are repeated any number of times to generate a set of alignment marks on any number of additional regions based on any previously generated set of alignment marks. In some embodiments, each additional region partially overlaps any previously generated region and contains any previously generated set of alignment marks.

For example, in some embodiments, the operations 130 and 140 are repeated at least about 1 time, 2 times, 3 times, 4 times, 5 times, 6 times, 7 times, 8 times, 9 times, 10 times, 20 times, 30 times, 40 times, 50 times, 60 times, 70 times, 80 times, 90 times, 100 times, 200 times, 300 times, 400 times, 500 times, 600 times, 700 times, 800 times, 900 times, 1,000 times, 2,000 times. 3,000 times, 4.000 times, 5,000 times. 6,000 times, 7,000 times, 8,000 times, 9,000 times. 10,000 times, 20,000 times, 30,000 times. 40,000 times, 50,000 times, 60,000 times, 70,000 times, 80,000 times, 90,000 times, 100,000 times, 200,000 times, 300,000 times, 400,000 times, 500,000 times, 600,000 times, 700,000 times. 800,000 times, 900,000 times, 1,000,000 times, or more to generate at least about 1 set of alignment marks, 2 sets of alignment marks, 3 sets of alignment marks, 4 sets of alignment marks. 5 sets of alignment marks, 6 sets of alignment marks, 7 sets of alignment marks, 8 sets of alignment marks, 9 sets of alignment marks, 10 sets of alignment marks, 20 sets of alignment marks, 30 sets of alignment marks, 40 sets of alignment marks, 50 sets of alignment marks, 60 sets of alignment marks, 70 sets of alignment marks, 80 sets of alignment marks, 90 sets of alignment marks, 100 sets of alignment marks, 200 sets of alignment marks, 300) sets of alignment marks, 400 sets of alignment marks. 500 sets of alignment marks, 600 sets of alignment marks, 700 sets of alignment marks. 800 sets of alignment marks, 900 sets of alignment marks, 1.000 sets of alignment marks. 2.000 sets of alignment marks, 3,000 sets of alignment marks, 4.000 sets of alignment marks, 5,000 sets of alignment marks, 6,000 sets of alignment marks, 7.000 sets of alignment marks, 8,000 sets of alignment marks, 9,000 sets of alignment marks, 10,000 sets of alignment marks, 20,000 sets of alignment marks, 30,000 sets of alignment marks, 40,000 sets of alignment marks, 50,000 sets of alignment marks, 60,000 sets of alignment marks. 70,000 sets of alignment marks, 80,000 sets of alignment marks, 90.000 sets of alignment marks, 100,000 sets of alignment marks. 200,000 sets of alignment marks, 300,000 sets of alignment marks, 400,000 sets of alignment marks, 500,000 sets of alignment marks, 600,000 sets of alignment marks, 700,000 sets of alignment marks, 800,000 sets of alignment marks, 900,000 sets of alignment marks, 1,000,000 sets of alignment marks, or more in at least about 1 region, 2 regions, 3 regions, 4 regions, 5 regions, 6 regions, 7 regions. 8 regions, 9 regions, 10 regions, 20 regions, 30 regions, 40 regions, 50 regions, 60 regions, 70 regions. 80 regions. 90 regions, 100 regions, 200 regions. 300 regions, 400 regions, 500 regions, 600 regions, 700 regions, 800 regions, 900 regions. 1,000 regions, 2,000 regions, 3,000 regions. 4,000 regions, 5,000 regions, 6,000 regions, 7.000 regions, 8,000 regions, 9,000 regions, 10,000 regions, 20.000 regions, 30,000 regions, 40,000 regions. 50,000 regions, 60,000 regions, 70,000 regions. 80,000 regions, 90,000 regions, 100,000 regions, 200,000 regions, 300,000 regions, 400,000 regions, 500,000 regions, 600,000 regions, 700,000 regions, 800,000 regions, 900,000 regions, 1,000,000 regions, or more.

In some embodiments, operations 130 and 140 are repeated at most about 1,000,000 times, 900,000 times, 800,000 times, 700,000 times, 600,000 times, 500,000 times, 400,000 times, 300,000 times, 200,000 times, 100,000 times, 90,000 times, 80,000 times, 70,000 times, 60,000 times, 50,000 times, 40,000 times, 30,000 times, 20,000 times, 10,000 times, 9,000 times, 8,000 times. 7,000 times, 6,000 times, 5,000 times. 4,000 times, 3.000 times, 2,000 times, 1,000 times. 900 times, 800 times, 700 times, 600 times, 500 times, 400 times, 300 times, 200 times, 100 times, 90 times, 80 times, 70 times. 60 times. 50 times, 40 times, 30 times, 20 times, 10 times, 9 times, 8 times, 7 times, 6 times, 5 times, 4 times, 3 times, 2 times, or 1 time to generate at most about 1,000,000 sets of alignment marks, 900,000 sets of alignment marks, 800,000 sets of alignment marks, 700,000 sets of alignment marks, 600,000 sets of alignment marks, 500,000 sets of alignment marks, 400,000 sets of alignment marks, 300,000 sets of alignment marks, 200,000 sets of alignment marks, 100,000 sets of alignment marks, 90,000 sets of alignment marks. 80,000 sets of alignment marks, 70,000 sets of alignment marks, 60.000 sets of alignment marks, 50,000 sets of alignment marks. 40,000 sets of alignment marks, 30,000 sets of alignment marks, 20,000 sets of alignment marks, 10,000 sets of alignment marks, 9,000 sets of alignment marks, 8,000 sets of alignment marks, 7,000 sets of alignment marks, 6,000 sets of alignment marks, 5,000 sets of alignment marks, 4,000 sets of alignment marks, 3,000 sets of alignment marks, 2,000 sets of alignment marks, 1,000 sets of alignment marks, 900 sets of alignment marks, 800 sets of alignment marks, 700 sets of alignment marks, 600 sets of alignment marks, 500 sets of alignment marks, 400 sets of alignment marks, 300 sets of alignment marks, 200 sets of alignment marks, 100 sets of alignment marks, 90 sets of alignment marks, 80 sets of alignment marks, 70 sets of alignment marks, 60 sets of alignment marks, 50 sets of alignment marks, 40 sets of alignment marks, 30 sets of alignment marks, 20 sets of alignment marks, 10 sets of alignment marks, 9 sets of alignment marks. 8 sets of alignment marks. 7 sets of alignment marks, 6 sets of alignment marks, 5 sets of alignment marks, 4 sets of alignment marks, 3 sets of alignment marks, 2 sets of alignment marks, or 1 set of alignment marks in at most about 1,000,000 regions, 900,000 regions, 800,000 regions, 700,000 regions, 600,000 regions, 500,000 regions, 400,000 regions, 300,000 regions, 200,000 regions, 100,000 regions, 90,000 regions, 80,000 regions, 70,000 regions, 60,000 regions, 50,000 regions. 40,000 regions, 30,000 regions, 20,000 regions. 10,000 regions, 9,000 regions. 8,000 regions, 7,000 regions, 6,000 regions, 5,000 regions, 4,000 regions, 3,000 regions, 2,000 regions, 1,000 regions, 900 regions, 800 regions, 700 regions, 600 regions, 500 regions, 400 regions, 300 regions, 200 regions, 100 regions, 90 regions, 80 regions. 70 regions, 60 regions, 50 regions, 40 regions. 30 regions. 20 regions, 10 regions, 9 regions, 8 regions. 7 regions, 6 regions. 5 regions, 4 regions, 3 regions, 2 regions, or 1 region.

In some embodiments, operations 130 and 140 are repeated a number of times that is within a range defined by any two of the preceding values to generate a number of sets of alignment marks that is within a range defined by any two of the preceding values in a number of regions that is within a range defined by any two of the preceding values. For example, in some embodiments, operations 130 and 140 are repeated between 10,000 and 1,000,000 times, between 10,000 and 500,000 times, between 10,000 and 100,000 times, between 50,000 and 1,000,000 times, between 50,000 and 500,000 times, between 50,000 and 100,000 times, between 100,000 and 1,000,000 times, or between 100,000 and 500,000 times to generate between 10,000 and 1,000,000 sets of alignments marks, between 10,000 and 500.000 sets of alignments marks, between 10,000 and 100,000 sets of alignments marks, between 50,000 and 1,000,000 sets of alignments marks, between 50,000 and 500,000 sets of alignments marks, between 50,000 and 100,000 sets of alignments marks, between 100,000 and 1,000,000 sets of alignments marks, or between 100,000 and 500,000 sets of alignments marks in between 10,000 and 1.000,000 regions, between 10,000 and 500,000 regions, between 10,000 and 100,000 regions, between 50,000 and 1,000,000 regions, between 50,000 and 500.000 regions, between 50,000 and 100,000 regions, between 100,000 and 1,000,000 regions, or between 100,000 and 500.000 regions.

In some embodiments, a set of alignment marks comprises at least about 1 alignment mark. 2 alignment marks, 3 alignment marks, 4 alignment marks, 5 alignment marks, 6 alignment marks, 7 alignment marks, 8 alignment marks, 9 alignment marks, 10 alignment marks, or more. In some embodiments, a set of alignment marks comprises at most about 10 alignment marks, 9 alignment marks, 8 alignment marks, 7 alignment marks, 6 alignment marks, 5 alignment marks, 4 alignment marks, 3 alignment marks, 2 alignment marks, or 1 alignment mark. In some embodiments, a set of alignment marks comprises a number of alignment marks that is within a range defined by any two of the preceding values.

As an example, a Boeing 747 jet has wings whose upper surface area covers approximately 500 square meters. If the first or second optical processing systems have a FOV of 100 mm×100 mm, this amounts to approximately 50.000 regions just to cover the entire surface area of the wings. If the undersides of the wings, the tail surfaces, and the fuselage are also optically processed, this can amount to 250,000 regions or more.

In some embodiments, the method 100 further comprises using a third optical processing system to generate one or more structures on the first region, second region, or any other region described herein. In some embodiments, the one or more structures comprise one or more riblets. In some embodiments, the third optical processing system is the same as the first optical processing system or second optical processing system. In some embodiments, the third optical processing system is different from the first optical processing system or second optical processing system. In some embodiments, the third optical processing system comprises a laser processing system. In some embodiments, the third optical processing system comprises a pulsed laser processing system. In some embodiments, the third optical processing system is configured to generate laser pulses. In some embodiments, the laser pulses have any peak optical power described herein with respect to the first optical processing system. In some embodiments, the laser pulses have any pulse length described herein with respect to the first optical processing system. In some embodiments, the laser pulses have any pulse energy described herein with respect to the first optical processing system. In some embodiments, the laser pulses have any repetition rate described herein with respect to the first optical processing system. In some embodiments, the laser pulses have at least one wavelength described herein with respect to the first optical processing system.

In some embodiments, all sets of alignment marks are generated prior to generating any of the structures on the plurality of regions. In some embodiments, the generation of the sets of alignment marks is interleaved with the generation of the structures on the plurality of regions. For instance, in some embodiments, the first and second sets of alignment marks are generated, then the structures are generated in the first region, then the third set of alignment marks are generated, then the structures are generated in the second region, and so forth. In some embodiments, the sets of alignment marks and structures in the various regions are generated in any possible order.

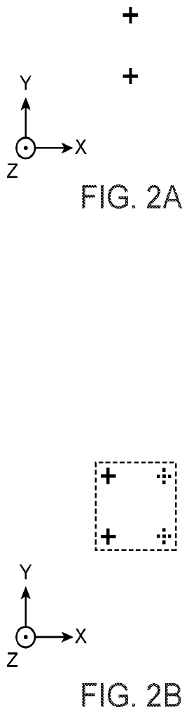

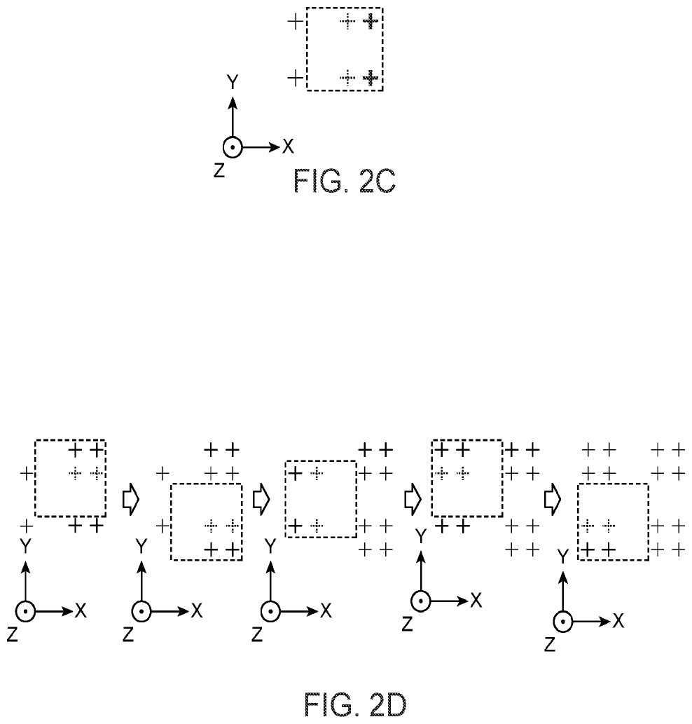

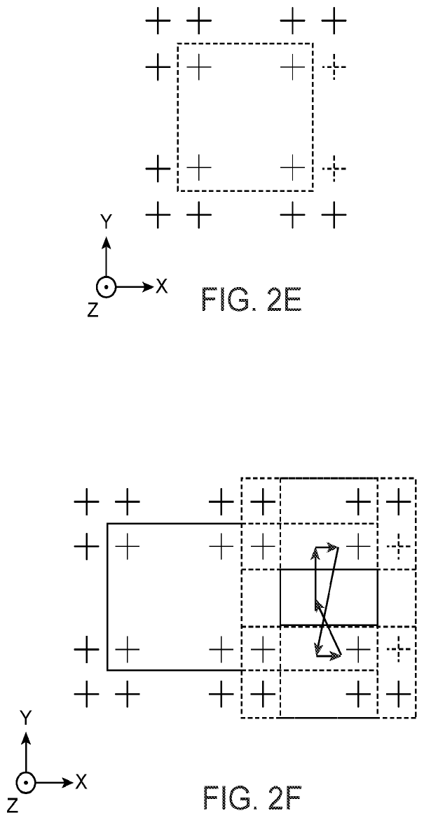

FIGS. 2A-2F show an example of the method of FIG. 1 carried out to optically process eight regions. In FIGS. 2A-2F, dashed plus signs represent previously generated alignment marks, while solid plus signs represent newly generated alignment marks.

As shown in FIG. 2A, a first set of alignment marks is generated on a first region of a surface. In some embodiments, the first set of alignment marks is generated using operations 110 and 120 described herein with respect to FIG. 1.

As shown in FIG. 2B, a second set of alignment marks is generated in a second region, illustrated as a dotted-line square, of the surface which contains the first set of alignment marks near its left edge. The second set of alignment marks is generated (to the right of the first set of alignment marks) by using the position of the first set of alignment marks to control the position and orientation of the first or second optical processing system. This may allow proper placement of the second set of alignment marks relative to first set of alignment marks, correcting positioning error of the first or second optical processing system. In some embodiments, the second set of alignment marks is generated using operations 110 and 120 of method 100 described herein with respect to FIG. 1.

As shown in FIG. 2C, a third set of alignment marks is generated on a third region of the surface which contains the second set of alignment marks. The third set of alignment marks is generated by using the position of the second set of alignment marks to control the position and orientation of the first or second optical processing system. This may allow proper placement of the third set of alignment marks relative to the second set of alignment marks, correcting positioning error of the first or second optical processing system. In some embodiments, the third set of alignment marks is generated using operations 130 and 140 of method 100 described herein with respect to FIG. 1.

As shown in FIG. 2D, the basic process is repeated to create fourth, fifth, sixth, seventh, and eighth sets of alignment marks for fourth, fifth, sixth, seventh, and eighth regions of the surface, respectively. For each new set of alignment marks, previous sets of alignment marks are generated by using the position of a previously generated set of alignment marks to control the position and orientation of the first or second optical processing system. This may allow proper placement of the fourth, fifth, sixth, seventh, or eighth sets of alignment marks relative to the third, fourth, fifth, sixth, or seventh sets of alignment marks, correcting positioning error of the first or second optical processing system. In some embodiments, the fourth, fifth, sixth, seventh, or eighth sets of alignment marks are generated using operations 130 and 140 of method 100 described herein with respect to FIG. 1. In some embodiments, a Tz deviation in the alignment mark causes an increase in the deviation in the X direction as the processing proceeds in the Y direction. In such cases, a position of the first, second, or third optical processing system may be detected with a Localizer and the position of the first, second, or third optical processing system may be corrected based on a difference between the detected position and an ideal position.

As shown in FIG. 2E, a first processing region (in this example, the first processing region is the same as the second region shown in FIG. 2B) is then optically processed to generate structures on the first processing region. In some embodiments, the structures are generated based on the position of alignment marks within the first through eighth regions. In some embodiments, the structures are generated using the third optical processing system described herein. In some embodiments, the structures comprise any structures described herein. For example, in some embodiments, the structures comprise any riblets described herein. In some embodiments, the structures in the first processing region over-write the first or second sets of alignment marks.

As shown in FIG. 2F, a sequence similar to that illustrated in FIG. 3D, illustrated by arrows, is used to generate additional alignment marks around the perimeter of a second processing region. Subsequently the second processing region is then optically processed to generate structures. The structures in the second processing region are generated based on the position of the alignment marks surrounding the perimeter of the second processing region. In some embodiments, the structures are generated using the third optical processing system described herein. For example, in some embodiments, the structures comprise any riblets described herein. In some embodiments, the structures in the second processing region over-write the first or second sets of alignment marks.

In some embodiments, the first, second, third, fourth, fifth, sixth, seventh, and eighth sets of alignment marks are generated prior to generating any of the structures on the first, second, third, fourth, fifth, sixth, seventh, or eighth processing regions. In some embodiments, the generation of the first, second, third, fourth, fifth, sixth, seventh, or eighth sets of alignment marks is interleaved with the generation of the structures on the first, second, third, fourth, fifth, sixth, seventh, or eighth processing regions. For instance, in some embodiments, the first and second sets of alignment marks are generated, then the structures are generated in the first processing region, then the third set of alignment marks are generated, then the structures are generated in the second processing region, and so forth. In some embodiments, the sets of alignment marks and structures in the various regions and processing regions are generated in any possible order.

As shown in FIGS. 2E and 2F, an observation area (such as an FOV) of the first or second optical processing system may be larger than any or all of the first, second, third, fourth, fifth, sixth, seventh, and eighth processing regions.

FIG. 3A shows an example of an alignment mark having a diamond shape. FIG. 3B shows an example of an alignment mark having a cross shape. FIG. 3C shows an example of an alignment mark having a manji shape comprising four pairs of parallel lines oriented along two perpendicular axes. FIG. 3D shows an example of an alignment mark having a Z shape. In some embodiments, the alignment marks are optically imaged and analyzed, for example, by using machine vision techniques such as edge-finding techniques. In some embodiments, a centroid of the alignment marks is detected to determine a position of the alignment marks. In some embodiments, a translation along an x-axis, translation along a y-axis, or rotation about a z-axis is determined by comparing a position, distance, or angle between lines making up the alignment marks. For example, in some embodiments, a position of the lines in the diamond-shaped alignment marks indicates an extent of translation along a y-axis (up and down in FIG. 3A). In some embodiments, a measured gap between the outer lines of the diamond-shaped alignment marks indicates a measure of translation along an x-axis (left and right in FIG. 3A). In some embodiments, a difference in a gap between the downward slanting line and the horizontal line and a gap between the upward slanting line and the horizontal line in the diamond-shape alignment marks indicates an extent of rotation about a z-axis. In some embodiments, an angle of a downward slanting line in the diamond-shaped alignment marks indicates an extent of rotation about a z-axis.

Although the alignment marks are shown as parallel lines oriented along perpendicular axes in FIGS. 3B-3D, the alignment marks need not be oriented in such a manner. For example, in some embodiments, the horizontal or vertical lines depicted in FIG. 3B are oriented at an angle to the horizon or at an angle to the normal to the horizon. In some embodiments, the angle is at least about 0 degrees, 5 degrees, 10 degrees, 15 degrees, 20 degrees, 25 degrees. 30 degrees, 35 degrees, 40 degrees, 35 degrees, or more. In some embodiments, the angle is at most about 45 degrees, 40 degrees, 35 degrees, 30 degrees, 25 degrees, 20 degrees. 15 degrees, 10 degrees, 5 degrees, or 0 degrees. In some embodiments, the angle is within a range defined by any two of the preceding values. In some embodiments, the horizontal and vertical lines depicted in FIG. 3B are not perpendicular to one another. In some embodiments, the horizontal and vertical lines intersect at any angle described herein. In some embodiments, any pair of horizontal or vertical lines in FIG. 3C are oriented at an angle to the horizon or at an angle to the normal to the horizon. In some embodiments, the angle is any angle described herein. In some embodiments, the alignment marks depicted in FIGS. 3B-3D further comprise any number of lines oriented at any angle described herein. In some embodiments, the alignment marks depicted in FIGS. 3B-3D further comprise any number of dots.

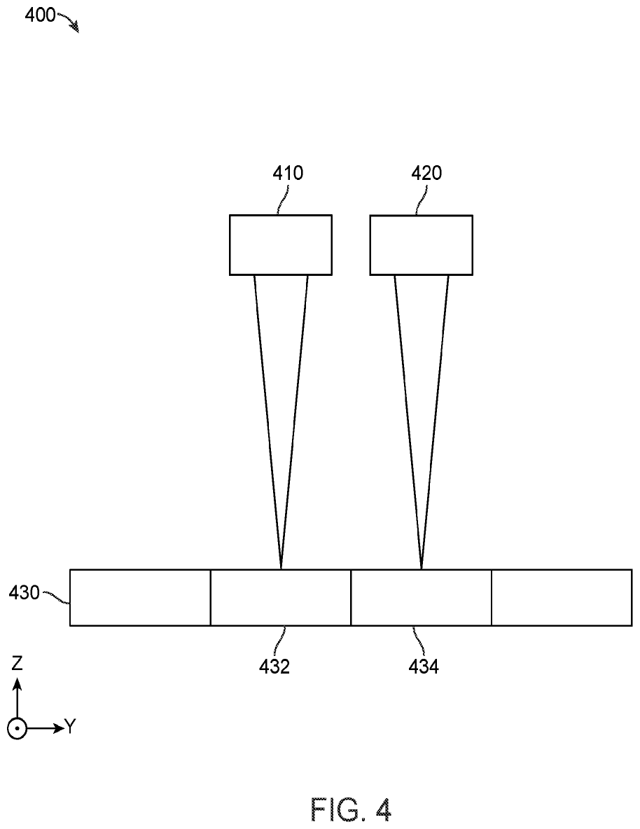

FIG. 4 shows a schematic depicting an exemplary system 400 for large-scale optical manufacturing. In the example shown, the system comprises a first optical processing system 410 and a second optical processing system 420. The first optical processing system may be similar to the first optical processing system described herein with respect to method 100 of FIG. 1. The second optical processing system may be similar to the second optical processing system described herein with respect to method 100 of FIG. 1. In some embodiments, the first optical processing system is configured to focus on a first region 432 of a surface 430, as described herein with respect to method 100 of FIG. 1. In some embodiments, the first optical processing system is configured to optically generate a first set of alignment marks on the first region, as described herein with respect to method 100 of FIG. 1. In some embodiments, the second optical processing system is configured to focus on a second region 434 of the surface 430, as described herein with respect to method 100 of FIG. 1. In some embodiments, the second optical processing system is configured to optically generate a second set of alignment marks on the second region, as described herein with respect to method 100 of FIG. 1. The system 400 may be configured to perform any of all of method 100, such as any or all of operations 110, 120, 130, and 140 described herein with respect to FIG. 1.

Although depicted as comprising first and second optical processing systems in FIG. 4, the system 400 may comprise any number of optical processing systems. In some embodiments, the system comprises at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more optical processing systems. In some embodiments, the system comprises at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 optical processing systems. In some embodiments, the system comprises a number of optical processing systems that is within a range defined by any two of the preceding values. In some embodiments, each optical processing system is configured to perform any or all of operations 110, 120, 130, and 140 described herein with respect to FIG. 1. In this manner, a plurality of optical processing systems may operate in parallel to generate the plurality of alignment marks on the surface in a reduced amount of time.

Additionally, systems are disclosed that can be used to perform the method 100 of FIG. 1, or any of operations 110, 120, 130, and 140, described herein. In some embodiments, the systems comprise one or more processors and memory coupled to the one or more processors. In some embodiments, the one or more processors are configured to implement one or more operations of method 100. In some embodiments, the memory is configured to provide the one or more processors with instructions corresponding to the operations of method 100. In some embodiments, the instructions are embodied in a tangible computer readable storage medium.

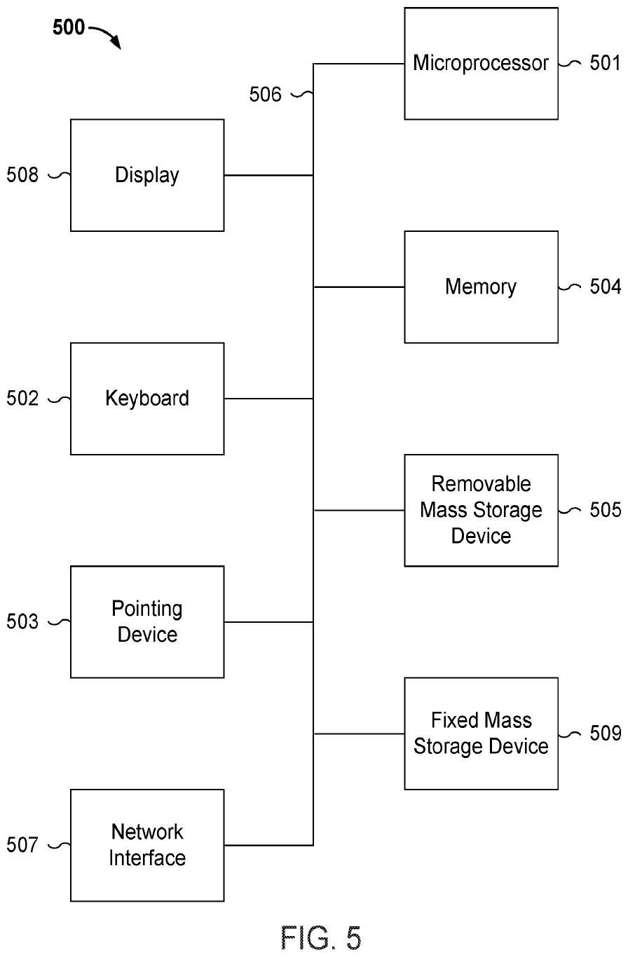

FIG. 5 is a block diagram of a computer system 500 used in some embodiments to perform portions of methods for large-scale optical manufacturing described herein (such as operation 110, 120, 130, or 140 of method 100 as described herein with respect to FIG. 1). In some embodiments, the computer system may be utilized as a component in systems for large-scale optical manufacturing described herein. FIG. 5 illustrates one embodiment of a general purpose computer system. Other computer system architectures and configurations can be used for carrying out the processing of the present invention. Computer system 500, made up of various subsystems described below, includes at least one microprocessor subsystem 501. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 500. Using instructions retrieved from memory 504, the microprocessor subsystem controls the reception and manipulation of input data, and the output and display of data on output devices.

The microprocessor subsystem 501 is coupled bi-directionally with memory 504, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 504 may include any suitable computer-readable storage media, described below, depending on whether, for example, data access needs to be bi-directional or uni-directional. The microprocessor subsystem 501 can also directly and very rapidly retrieve and store frequently needed data in a cache memory (not shown).

A removable mass storage device 505 provides additional data storage capacity for the computer system 500, and is coupled either bi-directionally (read/write) or uni-directionally (read only) to microprocessor subsystem 501. Storage 505 may also include computer-readable media such as magnetic tape, flash memory, signals embodied on a carrier wave, PC-CARDS, portable mass storage devices, holographic storage devices, and other storage devices. A fixed mass storage 509 can also provide additional data storage capacity. The most common example of mass storage 509 is a hard disk drive. Mass storage 505 and 509 generally store additional programming instructions, data, and the like that typically are not in active use by the processing subsystem. It will be appreciated that the information retained within mass storage 505 and 509 may be incorporated, if needed, in standard fashion as part of primary storage 504 (e.g., RAM) as virtual memory.

In addition to providing processing subsystem 501 access to storage subsystems, bus 506 can be used to provide access other subsystems and devices as well. In the described embodiment, these can include a display monitor 508, a network interface 507, a keyboard 502, and a pointing device 503, as well as an auxiliary input/output device interface, a sound card, speakers, and other subsystems as needed. The pointing device 503 may be a mouse, stylus, track ball, or tablet, and is useful for interacting with a graphical user interface.

The network interface 507 allows the processing subsystem 501 to be coupled to another computer, computer network, or telecommunications network using a network connection as shown. Through the network interface 507, it is contemplated that the processing subsystem 501 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 501 can be used to connect the computer system 500 to an external network and transfer data according to standard protocols. That is, method embodiments of the present invention may execute solely upon processing subsystem 501, or may be performed across a network such as the Internet, intranet networks, or local area networks, in conjunction with a remote processing subsystem that shares a portion of the processing. Additional mass storage devices (not shown) may also be connected to processing subsystem 501 through network interface 507.

An auxiliary I/O device interface (not shown) can be used in conjunction with computer system 500. The auxiliary I/O device interface can include general and customized interfaces that allow the processing subsystem 501 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape: optical media such as CD-ROM disks: magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 5 is but an example of a computer system suitable for use with the invention. Other computer systems suitable for use with the invention may include additional or fewer subsystems. In addition, bus 506 is illustrative of any interconnection scheme serving to link the subsystems. Other computer architectures having different configurations of subsystems may also be utilized.

### RECITATION OF EMBODIMENTS

Embodiment 1. A method for processing a surface comprising:
(a) optically generating at least one first alignment mark on a first region of a surface using a first optical processing system; and
(b) optically generating at least one second alignment mark on a second region of the surface based on a position of the at least one first alignment mark using a second optical processing system.

Embodiment 2. The method of Embodiment 1, wherein the at least one first alignment mark comprises a first set of alignment marks and wherein the at least one second alignment mark comprises a second set of alignment marks.

Embodiment 3. The method of Embodiment 1 or 2, wherein the second region is different from the first region.

Embodiment 4. The method of any one of Embodiments 1-3, wherein the first optical processing system or the second optical processing system comprise a laser processing system.

Embodiment 5. The method of any one of Embodiments 1-4, wherein the first optical processing system and the second optical processing system are different.

Embodiment 6. The method of any one of Embodiments 1-4, wherein the first optical processing system and the second optical processing system are the same.

Embodiment 7. The method of any one of Embodiments 1-6, wherein the surface is selected from the group consisting of: a wing of an aircraft, a fuselage of an aircraft, a propeller of an aircraft, a tail of an aircraft, a blade of a wind turbine, and a blade of a gas turbine.

Embodiment 8. The method of any one of Embodiments 1-7, wherein a first size of the first region corresponds to a first field of view (FOV) of the first optical processing system.

Embodiment 9. The method of any one of Embodiments 1-7, wherein a first size of the first region is smaller than a first FOV of the first optical processing system.

Embodiment 10. The method of any one of Embodiments 1-9, wherein a second size of the second region corresponds to a second FOV of the second optical processing system.

Embodiment 11. The method of any of one Embodiments 1-9, wherein a second size of the second region is smaller than a second FOV of the first optical processing system.

Embodiment 12. The method of any one of Embodiments 1-11, wherein the first and second regions partially overlap.

Embodiment 13. The method of any one of Embodiments 1-12, wherein (a) or (b) comprises marking the at least one first alignment mark on the first region or the at least one second alignment mark on the second region.

Embodiment 14. The method of Embodiment 13, wherein the first region or the second regions comprises a base coat and a top coat, and wherein (a) or (b) comprises burning the at least one first alignment mark or the at least one second alignment mark on the base coat.

Embodiment 15. The method of any one of Embodiments 1-14, wherein (a) or (b) comprises ablating the at least one first alignment mark on the first region or the at least one second alignment mark on the second region.

Embodiment 16. The method of Embodiment 15, wherein (a) or (b) comprises ablating the at least one first alignment mark on the first region or the at least one second alignment mark on the second region to an ablation depth that is less than a depth of structures to be generated on the first region or the second region.

Embodiment 17. The method of Embodiment 15, wherein the first region or the second region comprises a base coat and a top coat, and wherein (a) or (b) comprises ablating the at least one first alignment mark or the at least one second alignment mark on the base coat.

Embodiment 18. The method of any one of Embodiments 1-17, wherein the at least one first alignment mark comprises one or more guide stars projected on the surface.

Embodiment 19. The method of any one of Embodiments 1-18, wherein the at least one first alignment mark or the at least one second alignment mark is selected from the group consisting of: diamond-shaped alignment marks, cross-shaped alignment marks, manji-shaped alignment marks, and Z-shaped alignment marks.

Embodiment 20. The method of any one of Embodiments 1-19, further comprising using a third optical processing system to ablate one or more structures on the first region or the second region.

Embodiment 21. The method of Embodiment 20, wherein the one or more structures comprise one or more riblets.

Embodiment 22. The method of Embodiment 20 or 21, wherein the third optical processing system is the same as the first optical system or the second optical system.

Embodiment 23. The method of Embodiment 20 or 21, wherein the third optical processing system is different from the first optical processing system or the second optical processing system.

Embodiment 24. A method for processing a surface comprising:
(a) optically generating at least one first alignment mark on a first region of the surface using a first optical processing system; and
(b) processing the surface based on a position of the at least one first alignment mark using a second optical processing system.

Embodiment 25. The method of Embodiment 24, further comprising:
optically generating the at least one first alignment mark using a first optical processing system;
wherein the processing of the coat layer is performed using a second optical processing system.

Embodiment 26. A method for processing a coat layer comprising:
(a) detecting at least one first alignment mark formed below a coat layer through the coat layer; and
(b) processing the coat layer based on a position of the at least one first alignment mark below the coat layer.

Embodiment 27. The method of Embodiment 26, further comprising: forming the coat layer.

Embodiment 28. A system comprising:
a first optical processing system configured to: (i) optically generate at least one first alignment mark on a first region of a surface; and
a second optical processing system configured to: (ii) optically generate at least one second alignment mark on a second region of the surface based on a position of the at least one first alignment mark.

Embodiment 29. The system of Embodiment 28, wherein the at least one first alignment mark comprises a first set of alignment marks and wherein the at least one second alignment mark comprises a second set of alignment marks.

Embodiment 30. The system of Embodiment 28 or 29, wherein the second region is different from the first region.

Embodiment 31. The system of any one of Embodiments 28-30, wherein the first optical processing system or the second optical processing system comprise a laser processing system.

Embodiment 32. The system of any one of Embodiments 28-31, wherein the first optical processing system and the second optical processing system are different.

Embodiment 33. The system of any one of Embodiments 28-31, wherein the first optical processing system and the second optical processing system are the same.

Embodiment 34. The system of any one of Embodiments 28-33, wherein the surface is selected from the group consisting of: a wing of an aircraft, a fuselage of an aircraft, a propeller of an aircraft, a tail of an aircraft, a blade of a wind turbine, and a blade of a gas turbine.

Embodiment 35. The system of any one of Embodiments 28-34, wherein a first size of the first region corresponds to a first field of view (FOV) of the first optical processing system.

Embodiment 36. The system of any one of Embodiments 28-34, wherein a first size of the first region is smaller than a first FOV of the first optical processing system.

Embodiment 37. The system of any one of Embodiments 28-36, wherein a second size of the second region corresponds to a second FOV of the second optical processing system.

Embodiment 38. The system of any one of Embodiments 28-36, wherein a second size of the second region is smaller than a second FOV of the second optical processing system.

Embodiment 39. The system of any one of Embodiments 28-38, wherein the first and second regions partially overlap.

Embodiment 40. The system of any one of Embodiments 28-39, wherein (i) or (ii) comprises marking the at least one first alignment mark on the first region or the at least one second alignment mark on the second region.

Embodiment 41. The system of Embodiment 40, wherein the first region or the second regions comprises a base coat and a top coat, and wherein (i) or (ii) comprises burning the at least one first alignment mark or the at least one second alignment mark on the base coat.

Embodiment 42. The system of any one of Embodiments 28-41, wherein (i) or (ii) comprises ablating the at least one first alignment mark on the first region or the at least one second alignment mark on the second region.

Embodiment 43. The system of Embodiment 42, wherein (i) or (ii) comprises ablating the at least one first alignment mark on the first region or the at least one second alignment mark on the second region to an ablation depth that is less than a depth of structures to be generated on the first region or the second region.

Embodiment 44. The system of Embodiment 43, wherein the first region or the second region comprises a base coat and a top coat, and wherein (i) or (ii) comprises ablating the at least one first alignment mark or the at least one second alignment mark on the base coat.

Embodiment 45. The system of any one of Embodiments 28-44, wherein the at least one first alignment mark comprises one or more guide stars projected on the surface.

Embodiment 46. The system of any one of Embodiments 28-45, wherein the at least one first alignment mark or the at least one second alignment mark is selected from the group consisting of: diamond-shaped alignment marks, cross-shaped alignment marks, manji-shaped alignment marks, and Z-shaped alignment marks.

Embodiment 47. The system of any one of Embodiments 28-46, further comprising a third optical processing system configured to ablate one or more structures on the first region or the second region.

Embodiment 48. The system of Embodiment 47, wherein the one or more structures comprise one or more riblets.

Embodiment 49. The system of Embodiment 47 or 48, wherein the third optical system is the same as the first optical processing system or the second optical processing system.

Embodiment 50. The system of Embodiment 47 or 48, wherein the third optical system is different from the first optical processing system or the second optical processing system.

1. A method for processing a surface comprising:
(a) optically projecting at least one alignment mark on a first region of a surface using a first optical processing system; and
(b) optically forming a structure on a second region of the surface based on a position of the at least one alignment mark using a second optical processing system.

2. The method of claim 1, wherein the at least one alignment mark comprises a first set of alignment marks.

3. The method of claim 1, wherein the second region is different from the first region.

4. The method of claim 1, wherein the first optical processing system or the second optical processing system comprise a laser processing system.

5. The method of claim 1, wherein the first optical processing system and the second optical processing system are different

6. The method of claim 1, wherein the first optical processing system and the second optical processing system are the same.

7. The method of claim 1, wherein the surface is selected from the group consisting of: a wing of an aircraft, a fuselage of an aircraft, a propeller of an aircraft, a tail of an aircraft, a blade of a wind turbine, and a blade of a gas turbine.

8. The method of claim 1, wherein a first size of the first region corresponds to a first field of view (FOV) of the first optical processing system.

9. The method of claim 1, wherein a first size of the first region is smaller than a first FOV of the first optical processing system.

10. The method of claim 1, wherein a second size of the second region corresponds to a second FOV of the second optical processing system.

11. The method of claim 1, wherein a second size of the second region is smaller than a second FOV of the first optical processing system.

12. The method of claim 1, wherein the first and second regions partially overlap.

13. The method of claim 1, wherein (a) or (b) comprises marking the at least one alignment mark on the first region or at least one second alignment mark on the second region.

14. The method of claim 13, wherein the first region or the second regions comprises a base coat and a top coat, and wherein (a) or (b) comprises burning the at least one alignment mark or at least one second alignment mark on the base coat.

15. The method of claim 1, wherein (a) or (b) comprises ablating the at least one alignment mark on the first region or at least one second alignment mark on the second region.

16. The method of claim 15, wherein (a) or (b) comprises ablating the at least one alignment mark on the first region or at least one second alignment mark on the second region to an ablation depth that is less than a depth of structures to be generated on the first region or the second region.

17. The method of claim 15, wherein the first region or the second region comprises a base coat and a top coat, and wherein (a) or (b) comprises ablating the at least one alignment mark or at least one second alignment mark on the base coat.

18. The method of claim 1, wherein the at least one alignment mark comprises one or more guide stars projected on the surface.

19. The method of claim 1, wherein the at least one alignment mark or at least one second alignment mark is selected from the group consisting of: diamond-shaped alignment marks, cross-shaped alignment marks, manji-shaped alignment marks, and Z-shaped alignment marks.

20. The method of claim 1, further comprising using a third optical processing system to ablate one or more structures on the first region or the second region.

21. The method of claim 20, wherein the one or more structures comprise one or more riblets.

22. The method of claim 20, wherein the third optical processing system is the same as the first optical system or the second optical system.

23. The method of claim 20, wherein the third optical processing system is different from the first optical processing system or the second optical processing system.

24. The method of claim 1, wherein
the second region partially overlaps the first region,
the forming the structure includes overwriting the at least one alignment mark.

25. A method for processing a surface comprising:
(a) forming a structure on a first region of the surface by irradiating the first region with processing light from a processing system;
(b) detecting the structure formed on the first region;
(c) forming a structure on a second region, which is different from the first region, by irradiating the second region on the surface with the processing light from the processing system based on a detected result of the structure;
(d) detecting a position of the processing system by a Localizer; and
(e) correcting the position of the processing system by using a detected result by the Localizer.

26. An apparatus configured to process a surface comprising:
a first optical processing system configured to optically project at least one alignment mark on a first region of a surface; and
a second optical processing system configured to optically form a structure on a second region of the surface based on a position of the at least one alignment mark.

27. An apparatus configured to process a surface comprising:
a processing apparatus configured to form a structure on a first region of the surface by irradiating the first region with processing light;
a detection apparatus configured to detect the structure formed on the first region;
a Localizer configured to detect a position of the processing apparatus; and
a position correction apparatus configured to correct the position of the processing apparatus by using a detected result by the Localizer,
the processing apparatus being configured to form a structure on a second region, which is different from the first region, by irradiating the second region on the surface with the processing light based on a detected result of the structure.
